(19) United States
(12) Patent Application Publication
(10) Pub. No.: US 2018/0194648 A1
(43) Pub. Date: Jul. 12, 2018

(54) ELECTROLYTIC APPARATUS

(71) Applicant: JDM Health Medical Technology Co., LTD., Jiaxing City (CN)

(72) Inventor: Dan YANG, Jiaxing City (CN)

(21) Appl. No.: 15/482,398

(22) Filed: Apr. 7, 2017

(30) Foreign Application Priority Data
Jan. 12, 2017 (CN) 201710021807.7

(51) Int. Cl. C02F 1/461

(52) U.S. Cl. CPC C02F 1/4618; C02F 2001/4619; C02F 2201/46155; C02F 2201/46145; C02F 2201/46115

(57) ABSTRACT

Provided is an electrolytic apparatus including an electrolytic tank. The electrolytic tank includes a cathode chamber provided therein with a negative electrode and an anode chamber provided therein with a positive electrode. The cathode and anode chambers are separated by an electrolytic diaphragm unit which only allows ions to pass therethrough. The electrolytic apparatus further includes electrolyte and generated water circulating pipelines. Electrolyte is provided inside the electrolyte circulating pipeline, and is circulated in the electrolyte circulating pipeline and the anode chamber which are communicated. Generated water is circulated in the generated water circulating pipeline and the cathode chamber which are communicated. The generated water circulating pipeline includes a water supply port configured to continuously supply raw water into the generated water circulating pipeline, and a water discharge port configured to discharge finally generated water out, where both of the water supply and discharge ports are provided valves thereon.

### TECHNICAL FIELD

The present invention relates to the field of electrolytic apparatus, and particularly to an electrolytic apparatus.

### BACKGROUND ART

Electrolysis means a process performed in such a manner that a positive electrode and a negative electrode are added into electrolyte (a salt solution, a sodium hydroxide aqueous solution or the like) and energized, with an electrolytic diaphragm provided between the positive electrode and the negative electrode. Since the electrolytic diaphragm only allows electrons to pass therethrough, acidic water can be generated around the positive electrode and alkaline water can be generated around the negative electrode.

A first generation of electrolytic apparatus includes an electrolytic tank 10 and an electrolyte tank 20, as shown in FIG. 1. The electrolyte tank 20 is directly communicated with the electrolytic tank 10. The electrolytic tank 10 is divided by an electrolytic diaphragm unit 130 into a cathode chamber 110 and an anode chamber 120. A negative electrode 111 is provided within the cathode chamber 110, and a positive electrode 121 is provided within the anode chamber 120. The yield of alkaline water is increased by carrying out the electrolysis with water continuously supplied from a water supply port 140. However, the first generation of electrolytic apparatus has a very low electrolytic efficiency and fails to produce strongly alkaline water with a high PH value.

In order to increase the electrolytic efficiency and allow a mass of current to flow efficiently, additional electrodes are added to enable more current to flow into the water, so as to produce strongly alkaline water with a high PH value. A second generation of electrolytic apparatus adopts the method of adding additional electrodes. As shown in FIG. 2, the second generation of electrolytic apparatus includes a plurality of electrolytic tanks 10. Each of the electrolytic tanks 10 includes an alkaline water outlet 151 and an acid water outlet 152. All the alkaline water outlets 151 are communicated with each other and thus form an alkaline water producing port 160. All the acid water outlets 152 are communicated with each other and thus form an acid water producing port 170.

Although the second generation of electrolytic apparatus makes the electrolytic efficiency enhanced in some degree, it still has the following problems.

First, as for an existing electrolytic apparatus, electrolyte is usually blended into water which is used as raw water, before the electrolysis is carried out. As such, partial electrolyte would remain in the electrolyzed water as finally produced, that is, there would be residuals in the electrolyzed water for use. In addition, such residuals would react with ions in the electrolyzed water, which decreases the PH value of the electrolyte and produces precipitates, and thus lowers the quality of the finally generated water.

Second, with the addition of electrodes, the electrolytic tank tends to have a complicated construction which is prone to failures, and thus the electrolytic tank itself is vulnerable to aging problems in use. As a result, the pH value is kept from increasing any further, and there is no guarantee for a necessary yield. In this case, the electrodes and electrolytic diaphragms in the electrolytic tank have to be replaced, which increases the cost of maintenance and operation.

Third, as the construction of the electrolytic apparatus becomes complicated and the running water from the water supply is generally hard water, metal ions (calcium, magnesium and the like) contained in the water are more likely to form incrustation scale inside such complicatedly constructed electrolytic tank, which causes blocking and current leakage to the electrolytic tank. If a purifying device is added to remove the metal ions in pretreatment, a reverse osmosis membrane for purifying the water will be frequently used, or a large amount of water will be wasted in repeatedly washing the purifying device. In this case, the amount of water used for washing is about 2 times of that required for generation, which substantially increases the cost of maintenance and operation.

Forth, in addition to producing alkaline water, the existing electrolytic apparatuses produce the same amount of acid water in the meantime, which is however not a desired product and thus needs to be discarded. Before being discarded, the acid water needs to be subjected to a neutralizing treatment which requires a large amount of water or strongly alkaline chemical substances, thereby resulting in more waste and further increasing the cost of maintenance and operation.

In order to solve the problem that electrolyte is blended in the electrolyzed water, the existing third generation of electrolytic apparatus, as shown in FIG. 3, adopts a solution in which the electrolyte is circulated in an enclosed tank, such that no electrolyte would be blended into the raw water. However, in order to increase the yield in actual production, the third generation of electrolytic apparatus includes a plurality of electrolytic tanks as shown in FIG. 3. Therefore, such an electrolytic apparatus has a more complicated construction, and does not solve other problems of the second generation of electrolytic apparatus.

### DISCLOSURE OF THE INVENTION

In order to overcome the deficiencies in the prior art, the present invention aims at providing an electrolytic apparatus and an electrolysis method, to solve the technical problems existing in the prior art that: the existing electrolytic apparatus is prone to failures and aging problems due to its complicated construction; the cost of maintenance and operation is increased as a purifying device is required to purify the raw water; the quality of the finally generated water is poor due to the electrolyte blended therein; and waste is caused since a large amount of unnecessary acid water is also generated during the production of the alkaline water.

An embodiment of the present invention provides an electrolytic apparatus, which includes an electrolytic tank, where the electrolytic tank includes a cathode chamber and an anode chamber. The cathode chamber is provided therein with a negative electrode, and the anode chamber is provided therein with a positive electrode. The cathode chamber and the anode chamber are separated from each other by an electrolytic diaphragm unit which only allows ions to pass therethrough. The electrolytic apparatus further includes an electrolyte circulating pipeline and a generated water circulating pipeline. The electrolytic tank is provided thereon with an air discharge port for air discharge. Electrolyte is provided inside the electrolyte circulating pipeline, and the electrolyte circulating pipeline is communicated with the anode chamber, so that the electrolyte is circulated in the electrolyte circulating pipeline and the anode chamber. The generated water circulating pipeline is communicated with the cathode chamber, so that the generated water is circulated in the generated water circulating pipeline and the cathode chamber. Furthermore, the generated water circulating pipeline includes a water supply port and a water discharge port, and both of the water supply port and the water discharge port are provided thereon with valves, for controlling opening and closing of the water supply port and the water discharge port. The water supply port is configured to continuously supply raw water into the generated water circulating pipeline, and the water discharge port is configured to discharge finally generated water out.

Preferably, the electrolytic diaphragm unit includes a perfluorosulfonic acid membrane which only allows positive ions to pass therethrough.

Preferably, the electrolytic diaphragm unit further includes two fixed frames, and the perfluorosulfonic acid membrane is fixed between the two fixed frames by crimping. The electrolytic diaphragm unit is connected fixedly with the electrolytic tank via the fixed frames.

Preferably, the electrolytic apparatus further includes an electrolyte supplying unit, and the electrolyte supplying unit includes an electrolyte storage unit and an electrolyte supplying pump. The electrolyte storage unit is communicated with the electrolyte circulating pipeline, and is configured to store the electrolyte. The electrolyte supplying pump is configured to transport the electrolyte stored in the electrolyte storage unit into the electrolyte circulating pipeline.

Preferably, the electrolytic apparatus further includes a cooling system configured to lower overall temperature of the electrolyte circulating pipeline.

Preferably, the cooling system includes a cooling water tank, a cooling coil and a cooling water circulating pump. The cooling water tank is communicated with the cooling coil, and the cooling water tank is configured to accommodate cooling water and supply the cooling water to the cooling coil. The cooling water circulating pump is configured to supply power for circulating the cooling water.

Preferably, the electrolyte circulating pipeline includes an electrolyte circulating pump and an electrolyte circulating sensor. The electrolyte circulating pump is configured to supply power for circulating the electrolyte. The electrolyte circulating sensor is configured to calculate the number of circulations of the electrolyte. The generated water circulating pipeline includes a generated water circulating pump and a generated water circulating sensor. The generated water circulating pump is configured to supply power for circulating the generated water, and the generated water circulating sensor is configured to calculate the number of circulations of the generated water.

Preferably, the generated water circulating pipeline includes a generated water tank, and the generated water tank is provided with an upper limit and a lower limit for liquid level. If strongly alkaline water, which reaches a standard, is generated, the valve at the water discharge port is opened to enable water discharge; and once a liquid level within the generated water tank reaches the lower limit, the water discharge is stopped. Once the water discharge is stopped, the valve at the water supply port is opened to enable water supply for the generated water tank; and if the liquid level within the generated water tank reaches the upper limit, the water supply is stopped.

Preferably, the electrolytic tank is in number of more than one.

Preferably, each of the electrolyte circulating pipeline and the generated water circulating pipeline is provided therein with a full-water detection sensor and a water-shortage detection sensor. When a liquid level within the electrolyte circulating pipeline or the generated water circulating pipeline reaches a certain value, the respective full-water detection sensor sends an alarm. When the liquid level within the electrolyte circulating pipeline or the generated water circulating pipeline is below another certain value, the respective water-shortage detection sensor sends an alarm, and then the electrolytic apparatus stops.

The electrolytic apparatus as provided by embodiments of the present invention includes an electrolytic tank, where the electrolytic tank includes a cathode chamber and an anode chamber. The cathode chamber is provided therein with a negative electrode, and the anode chamber is provided therein with a positive electrode. The cathode chamber and the anode chamber are separated from each other by an electrolytic diaphragm unit, and the electrolytic diaphragm unit only allows ions to pass therethrough. The electrolytic apparatus further includes an electrolyte circulating pipeline and a generated water circulating pipeline. The electrolytic tank is provided thereon with an air discharge port for air discharge. Electrolyte is provided inside the electrolyte circulating pipeline, and the electrolyte circulating pipeline is communicated with the anode chamber, so that the electrolyte is circulated in the electrolyte circulating pipeline and the anode chamber. The generated water circulating pipeline is communicated with the cathode chamber, so that the generated water is circulated in the generated water circulating pipeline and the cathode chamber. Furthermore, the generated water circulating pipeline includes a water supply port and a water discharge port, and both of the water supply port and the water discharge port are provided thereon with valves, for controlling opening and closing of the water supply port and the water discharge port. The water supply port is configured to continuously supply raw water into the generated water circulating pipeline, and the water discharge port is configured to discharge finally generated water out. Different from the existing electrolytic apparatus, in the circulating system of the electrolytic apparatus as provided by the embodiments of the present invention, at a side where the electrolyte is present, the electrolyte is only circulated in the electrolyte circulating pipeline and the anode chamber, whereas at a side where the generated water is present, the generated water is only circulated in the generated water circulating pipeline and the cathode chamber. As the electrolyte and the generated water each are continuously circulated, the generated water is concentrated as it passes through the generated water circulating pipeline many times. Once reaching a designated pH value, a certain amount of the generated water is discharged as strongly alkaline water. As the amount of the generated water is reduced after the discharging of a part thereof, raw water of a same amount as that of the discharged part is added, and then the process of the circulation and concentration will be repeated until the pH reaches the designated value again. By adopting this circulation method with the water discharged at one side, no electrolyte would be blended into the side where the generated water is present, and thus no electrolyte residual would exist in the finally generated electrolyzed water. Furthermore, the electrolytic apparatus as provided by the embodiments of the present invention is simple in construction, and increases the pH value by circulating and concentrating the generated water, and therefore, such an electrolytic apparatus is less prone to failures, and is highly durable, and easy to maintain and manage, thereby substantially reducing the cost of operation. And due to the simple construction of the electrolytic apparatus, running water may be introduced directly into the generated water circulating pipeline without purification in advance, which greatly reduces the cost of maintenance and operation. Furthermore, the electrolytic apparatus as provided by the embodiments of the present invention produces only strongly alkaline water, that is, no acid water is produced, which means no waste water will be produced. This avoids waste of cost and time as required in the neutralization of waste water.

### BRIEF DESCRIPTION OF DRAWINGS

For illustrating embodiments of the present invention or technical solutions in the prior art more clearly, drawings necessary for the description of the embodiments or the prior art will be introduced briefly below. Apparently, the drawings in the following description are merely illustrative of some embodiments of the present invention, and for those ordinarily skilled in the art, other relevant drawings can also be obtained in light of these drawings, without paying any inventive effort.

FIG. 1 is a schematic structural diagram of the existing first generation of electrolytic apparatus;

FIG. 2 is a schematic structural diagram of the existing second generation of electrolytic apparatus;

FIG. 3 is a schematic structural diagram of the existing third generation of electrolytic apparatus;

FIG. 4 is a schematic structural diagram of an electrolytic apparatus as provided by an embodiment of the present invention;

FIG. 5 is another schematic structural diagram of an electrolytic apparatus as provided by an embodiment the present invention; and

FIG. 6 is an exploded view of an electrolytic diaphragm unit of the electrolytic apparatus as provided by the embodiment of the present invention.

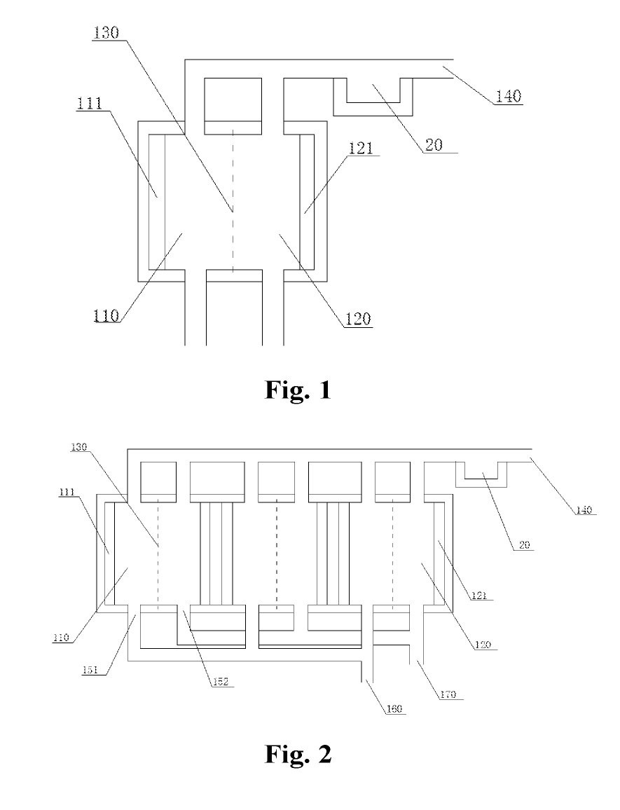

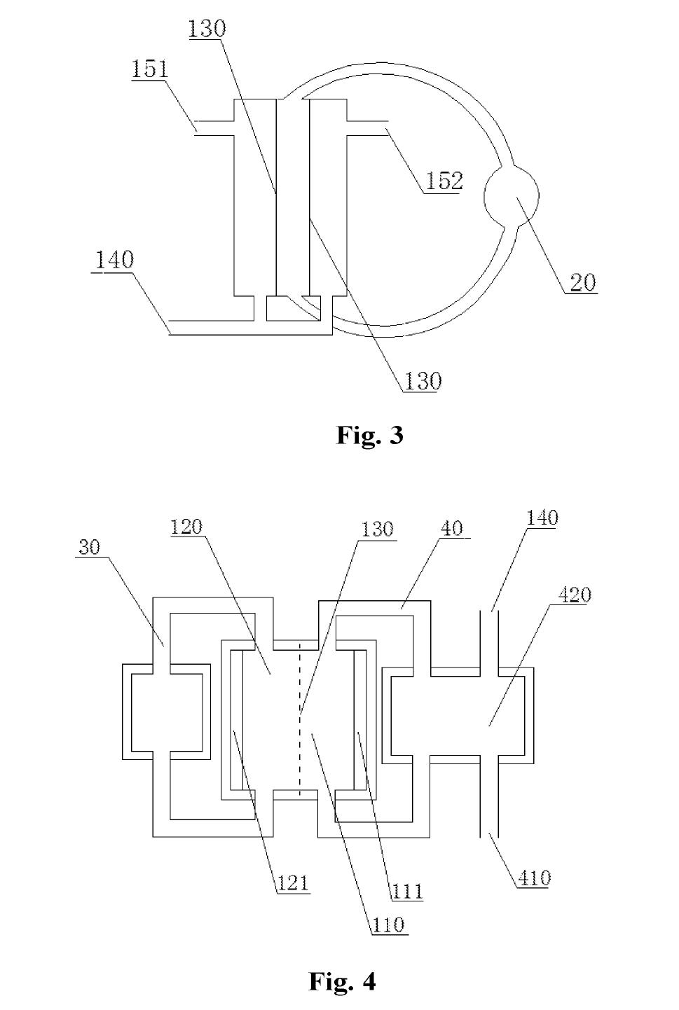

Reference signs: 10—electrolytic tank; 110—cathode chamber; 111—negative electrode; 120—anode chamber; 121—positive electrode; 130—electrolytic diaphragm unit; 131—perfluorosulfonic acid membrane; 132—fixed frame; 140—water supply port; 151—alkaline water outlet; 152—acid water outlet; 160—alkaline water producing port; 170—acid water producing port; 20—electrolyte tank; 30—electrolyte circulating pipeline; 40—generated water circulating pipeline; 410—water discharge port; 420—generated water tank; 50—cooling system.

### DETAILED DESCRIPTION OF EMBODIMENTS

Technical solutions of the present invention will be described below clearly and completely in conjunction with the drawings. Apparently, the embodiments as described are only some but not all of the embodiments of the present invention. All the other embodiments obtained by those ordinarily skilled in the art without any inventive effort, in light of the embodiments of the present invention, will fall within the scope of protection of the present invention.

In the description of the present invention, it shall be noted that orientational or positional relations indicated by terms, such as “upper” and “lower”, are based on the orientational or positional relations as shown in the drawings, and these terms are only intended to describe the present invention and simplify the description, but not to indicate or imply that the referred apparatus or element must be in a particular orientation or must be constructed and operated in a particular orientation, and therefore should not be construed as limiting the present invention. In addition, terms, such as “first”, “second” and “third”, are only descriptive and shall not be construed as indicating or implying relative importance.

It shall be noted in the description of the present invention that, unless otherwise specified and defined, terms “communicate” and “connect” shall be construed in an inclusive sense. For example, it may be a fixed connection, or may also be a removable connection, or an integrated connection; it may be a mechanical connection, or may also be an electrical connection; and it may be a direct connection, or may also be an indirect connection via an intermediate medium, or an internal communication between two elements. The above terms will be understood by those ordinarily skilled in the art in their specific senses in the present invention as appropriate.

The present invention provides an electrolytic apparatus, and particular embodiments thereof are given as follows.

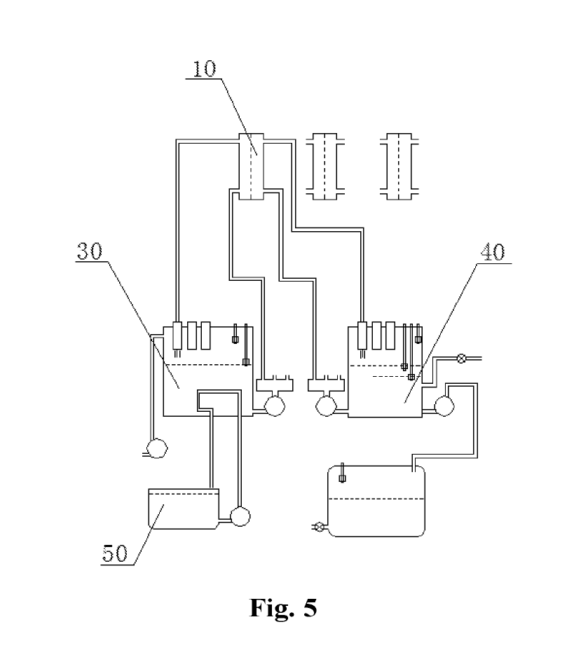

As shown in FIGS. 4 and 5, the electrolytic apparatus as provided by an embodiment of the present invention includes an electrolytic tank 10, and the electrolytic tank 10 includes a cathode chamber 110 and an anode chamber 120. The cathode chamber 110 is provided therein with a negative electrode 111, and the anode chamber 120 is provided therein with a positive electrode 121. The cathode chamber 110 and the anode chamber 120 are separated from each other by an electrolytic diaphragm unit 130, and the electrolytic diaphragm unit 130 only allows ions to pass therethrough. The electrolytic apparatus further includes an electrolyte circulating pipeline 30 and a generated water circulating pipeline 40. The electrolytic tank 10 is provided thereon with an air discharge port for air discharge. Electrolyte is provided inside the electrolyte circulating pipeline 30, and the electrolyte circulating pipeline 30 is communicated with the anode chamber 120, so that the electrolyte is circulated in the electrolyte circulating pipeline 30 and the anode chamber 120. The generated water circulating pipeline 40 is communicated with the cathode chamber 110, so that the generated water is circulated in the generated water circulating pipeline 40 and the cathode chamber 110. Furthermore, the generated water circulating pipeline 40 includes a water supply port 140 and a water discharge port 410, and both of the water supply port 140 and the water discharge port 410 are provided thereon with valves for controlling the opening and closing of the water supply port 140 and the water discharge port 410. The water supply port 140 is configured to continuously supply raw water into the generated water circulating pipeline 40, and the water discharge port 410 is configured to discharge finally generated water out. Different from the existing electrolytic apparatus, in the circulating system of the electrolytic apparatus as provided by the embodiment of the present invention, at a side where the electrolyte is present, the electrolyte is only circulated in the electrolyte circulating pipeline 30 and the anode chamber 120, whereas at a side where the generated water is present, the generated water is only circulated in the generated water circulating pipeline 40 and the cathode chamber 110. As the electrolyte and the generated water each are continuously circulated, the generated water is concentrated as it passes through the generated water circulating pipeline 40 many times. Once reaching a designated pH value, a certain amount of the generated water is discharged as strongly alkaline water. As the amount of the generated water is reduced after the discharging of a part thereof, raw water of a same amount as that of the discharged part is added, and then the process of the circulation and concentration will be repeated until the pH reaches the designated value again. By adopting this circulation method with the water discharged at one side, no electrolyte would be blended into the side where the generated water is present, and thus no electrolyte residual would exist in the finally generated electrolyzed water. Furthermore, the electrolytic apparatus as provided by the embodiment of the present invention is simple in construction, and increases the pH value by circulating and concentrating the generated water, and therefore, such an electrolytic apparatus is less prone to failures, and is highly durable, and easy to maintain and manage, thereby substantially reducing the cost of operation. And due to the simple construction of the electrolytic apparatus, running water may be introduced directly into the generated water circulating pipeline 40 without purification in advance, which greatly reduces the cost of production and operation. Furthermore, the electrolytic apparatus as provided by the embodiment of the present invention produces only strongly alkaline water, that is, no acid water is produced, which means no waste water will be produced. This avoids waste of cost and time as required in the neutralization of waste water.

The electrolytic diaphragm unit 130 includes a perfluorosulfonic acid membrane 131, and the perfluorosulfonic acid membrane 131 only allows positive ions to pass therethrough. Perfluorosulfonic acid has high durability, high stability and high temperature resistance. The electrolytic diaphragm made of perfluorosulfonic acid has features that only positive ions, but not negative ions, are allowed to pass therethrough, and that no liquid is allowed to permeate therethrough, thus enabling a certain concentration of the ions in the generated water to be kept.

Specifically, in the cathode chamber 110, the water is ionized as current flows therethrough, thus producing hydrogen ions H⁺ and hydroxyl ions OH⁻. The hydrogen ions H⁺ are gathered at the negative electrode 111 and receive electrons e from the negative electrode 111, and thus hydrogen is generated therefrom and runs out from the water. As a result, the number of the hydrogen ions H⁺ in the water is reduced, and the alkalinity at the side where the generated water is present is increased gradually. Finally, alkaline water is generated at the side where the cathode chamber 110 is located.

Similarly, in the anode chamber 120, the water is ionized as current flows therethrough, thus producing hydrogen ions H⁺ and hydroxyl ions OH⁻. The hydroxyl ions OH⁻ are gathered at the positive electrode 121 and are deprived of their electrons, and thus oxygen is generated therefrom and runs out from the water. As a result, the number of hydroxyl ions OH⁻ in the water is reduced, whereas the number of hydrogen ions H⁺ is increased. In this case, the pH value in the anode chamber 120 would decrease, but under the neutralization of the strongly alkaline electrolyte present in the anode chamber 120, it will not become acidic. Meanwhile, the original strongly alkaline electrolyte becomes weakly alkaline gradually, and finally becomes neutral. Furthermore, the positive ions from the electrolyte in the anode chamber 120 pass through the electrolytic diaphragm unit 130 and move to the side where the cathode chamber 110 is located, which also contributes to the electrolyte becoming neutral.

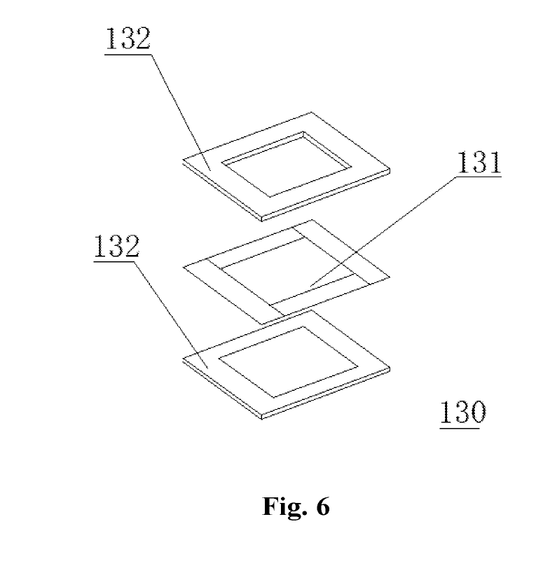

Furthermore, as shown in FIG. 6, the electrolytic diaphragm unit 130 further includes two fixed frames 132, with the perfluorosulfonic acid membrane 131 fixed between the two fixed frames 132 by crimping. The electrolytic diaphragm unit 130 is connected fixedly with the electrolytic tank 10 via the fixed frames 132. As there may be a need for the electrolytic apparatus to have the electrolytic diaphragm unit 130 replaced, such replacement will be facilitated by providing the perfluorosulfonic acid membrane 131 between the two fixed frames 132 so as to be connected fixedly with the electrolytic tank 10. In addition, as it is barely possible to bond the perfluorosulfonic acid membrane 131 and the fixed frames 132 made of polyvinyl chloride, the perfluorosulfonic acid membrane may have an enhanced durability when being fixed between the fixed frames 132 made of polyvinyl chloride by crimping. Highly alkali-resistant tape may be additionally applied to bonding the perfluorosulfonic acid membrane 131, to further enhance the firmness of the perfluorosulfonic acid membrane.

The electrolytic apparatus further includes an electrolyte supplying unit. The electrolyte supplying unit includes an electrolyte storage unit and an electrolyte supplying pump. The electrolyte storage unit is communicated with the electrolyte circulating pipeline 30, and is configured to store the electrolyte. The electrolyte supplying pump is configured to transport the electrolyte stored in the electrolyte storage unit into the electrolyte circulating pipeline 30.

The electrolytic apparatus further includes a cooling system 50. The cooling system 50 is configured to lower the temperature of the entire electrolyte circulating pipeline 30. Specifically, the cooling system 50 includes a cooling water tank, a cooling coil and a cooling water circulating pump. The cooling water tank is communicated with the cooling coil. The cooling water tank is configured to accommodate cooling water and supply the cooling water to the cooling coil. The cooling water circulating pump is configured to supply power for circulating the cooling water. As the generated water would not be replaced before the replacement of the electrolyte contained in the electrolyte circulating pipeline 30, a high flow of current in the electrolyte circulating pipeline 30 will cause the temperature of the electrolyte to rise gradually. Therefore, the cooling system 50 needs to be provided to reduce the temperature of the electrolyte, so as to ensure the service life of the electrolyte circulating pipeline 30.

The electrolyte circulating pipeline 30 includes an electrolyte circulating pump and an electrolyte circulating sensor. The electrolyte circulating pump is configured to supply power for circulating the electrolyte. The electrolyte circulating sensor is configured to calculate the number of circulations of the electrolyte. The generated water circulating pipeline 40 includes a generated water circulating pump and a generated water circulating sensor. The generated water circulating pump is configured to supply power for circulating the generated water. The generated water circulating sensor is configured to calculate the number of circulations of the generated water.

The generated water circulating pipeline 40 includes a generated water tank 420, and the generated water tank 420 is provided therein with an upper limit and a lower limit for liquid level. If strongly alkaline water, which reaches a standard is generated, the valve at the water discharge port 410 is opened to enable water discharge. Once the liquid level within the generated water tank 420 reaches the lower limit, the water discharge is stopped. Once the water discharge is stopped, the valve at the water supply port 140 is opened to enable water supply for the generated water tank 420. If the liquid level within the generated water tank 420 reaches the upper limit, the water supply is stopped. Specifically, the generated water tank 420 may be provided therein with an upper limit sensor and a lower limit sensor. In case of water discharge from the generated water tank 420, when the generated water arrives at the lower limit sensor, the water discharge is stopped, and at the same time, water supply for the generated water tank 420 is enabled. And when the generated water in the generated water tank 420 arrives at the upper limit sensor, the water supply is stopped.

In addition, each of the electrolyte circulating pipeline 30 and the generated water circulating pipeline 40 is provided therein with a full-water detection sensor and a water-shortage detection sensor. When a liquid level within the electrolyte circulating pipeline 30 or the generated water circulating pipeline 40 reaches a certain value, the respective full-water detection sensor sends an alarm. When the liquid level within the electrolyte circulating pipeline 30 or the generated water circulating pipeline 40 is below another certain value, the respective water-shortage detection sensor sends an alarm, and then the electrolytic apparatus stops.

The electrolytic tank 10 is in number of more than one. If there is a need to improve the production efficiency of strongly alkaline water for mass production, the number of the electrolytic tanks 10 may be increased, or the electrolytic tank 10 may be made larger.

The most important feature of the method for electrolyzing raw water with the electrolytic apparatus as provided by the embodiment of the present invention lies in that the pH value of the finally generated water may be increased and controlled based on the duration of the circulation. At the side where the generated water tank 30 is located, the pH value of the generated water within the generated water circulating pipeline 40 will reach a certain value after a certain period of time of circulation. When the desired pH value is reached, a certain amount of the generated water is discharged, and the insufficiency caused by the discharging of the generated water will be supplemented. As the pH value of the generated water in the generated water circulating pipeline 40 decreases after the water supply, the circulation needs to be repeated for a certain period of time, so as to increase the pH value. During such a process, only three periods of time, i.e., a period of time for water supply, a period of time for circulation and a period of time for water discharge, are involved. The sum of the three periods of time form the period of time required for increasing the pH value. In actual production, the generated water of different pH values may be obtained by just adjusting the period of time required for circulation. Furthermore, in actual production, the apparatus can work normally by simply repeating the three steps of water supply, circulation and water discharge, thereby enabling continuous production.

To sum up, the electrolytic apparatus as provided by the embodiment of the present invention includes an electrolytic tank 10, and the electrolytic tank 10 includes a cathode chamber 110 and an anode chamber 120. The cathode chamber 110 is provided therein with a negative electrode 111, and the anode chamber 120 is provided therein with a positive electrode 121. The cathode chamber 110 and the anode chamber 120 are separated from each other by an electrolytic diaphragm unit 130, and the electrolytic diaphragm unit 130 only allows ions to pass therethrough. The electrolytic apparatus further includes an electrolyte circulating pipeline 30 and a generated water circulating pipeline 40. The electrolytic tank 10 is provided thereon with an air discharge port for air discharge. Electrolyte is provided inside the electrolyte circulating pipeline 30, and the electrolyte circulating pipeline 30 is communicated with the anode chamber 120, so that the electrolyte is circulated in the electrolyte circulating pipeline 30 and the anode chamber 120. The generated water circulating pipeline 40 is communicated with the cathode chamber 110, so that the generated water is circulated in the generated water circulating pipeline 40 and the cathode chamber 110. Furthermore, the generated water circulating pipeline 40 includes a water supply port 140 and a water discharge port 410, and both of the water supply port 140 and the water discharge port 410 are provided thereon with valves for controlling the opening and closing of the water supply port 140 and the water discharge port 410. The water supply port 140 is configured to continuously supply raw water into the generated water circulating pipeline 40, and the water discharge port 410 is configured to discharge finally generated water out. Different from the existing electrolytic apparatus, in the circulating system of the electrolytic apparatus as provided by the embodiment of the present invention, at a side where the electrolyte is present, the electrolyte is only circulated in the electrolyte circulating pipeline 30 and the anode chamber 120, whereas at a side where the generated water is present, the generated water is only circulated in the generated water circulating pipeline 40 and the cathode chamber 110. As the electrolyte and the generated water each are continuously circulated, the generated water is concentrated as it passes through the generated water circulating pipeline 40 many times. Once reaching a designated pH value, a certain amount of the generated water is discharged as strongly alkaline water. As the amount of the generated water is reduced after the discharging of a part thereof, raw water of a same amount as that of the discharged part is added, and then the process of the circulation and concentration will be repeated until the pH reaches the designated value again. By adopting this circulation method with the water discharged at one side, no electrolyte would be blended into the side where the generated water is present, and thus no electrolyte residual would exist in the finally generated electrolyzed water. Furthermore, the electrolytic apparatus as provided by the embodiment of the present invention is simple in construction, and increases the pH value by circulating and concentrating the generated water, and therefore, such an electrolytic apparatus is less prone to failures, and is highly durable, and easy to maintain and manage, thereby substantially reducing the cost of operation. And due to the simple construction of the electrolytic apparatus, running water may be introduced directly into the generated water circulating pipeline 40 without purification in advance, which greatly reduces the cost of production and operation. Furthermore, the electrolytic apparatus as provided by the embodiment of the present invention produces only strongly alkaline water, that is, no acid water is produced, which means no waste water will be produced. This avoids waste of cost and time as required in the neutralization of waste water.

At last, it should be noted that the above embodiments are only illustrative of the technical solutions of the present invention and not limiting. Although the present invention has been described in detail with reference to the foregoing embodiments, those ordinarily skilled in the art shall understand that they may make modifications to the technical solutions as illustrated by the foregoing embodiments or substitute part or all of the technical features with equivalents. Such modifications and substitutions shall not make the essence of the respective technical solutions depart from the scope of the technical solutions as illustrated by those embodiments of the present invention.

1. An electrolytic apparatus, comprising an electrolytic tank comprising a cathode chamber and an anode chamber, the cathode chamber being provided therein with a negative electrode and the anode chamber being provided therein with a positive electrode, the cathode chamber and the anode chamber being separated from each other by an electrolytic diaphragm unit, the electrolytic diaphragm unit only allowing ions to pass therethrough, wherein the electrolytic apparatus further comprises an electrolyte circulating pipeline and a generated water circulating pipeline;
the electrolytic tank is provided thereon with an air discharge port for air discharge;
electrolyte is provided inside the electrolyte circulating pipeline, and the electrolyte circulating pipeline is communicated with the anode chamber, so that the electrolyte is circulated in the electrolyte circulating pipeline and the anode chamber;
the generated water circulating pipeline is communicated with the cathode chamber, so that generated water is circulated in the generated water circulating pipeline and the cathode chamber; and
the generated water circulating pipeline comprises a water supply port and a water discharge port, both of the water supply port and the water discharge port are provided thereon with valves for controlling opening and closing of the water supply port and the water discharge port, wherein the water supply port is configured to continuously supply raw water into the generated water circulating pipeline, and the water discharge port is configured to discharge final strongly alkaline water out.

2. The electrolytic apparatus according to claim 1, wherein the electrolytic diaphragm unit comprises a perfluorosulfonic acid membrane, and the perfluorosulfonic acid membrane only allows positive ions to pass therethrough.

3. The electrolytic apparatus according to claim 2, wherein the electrolytic diaphragm unit further comprises two fixed frames, and the perfluorosulfonic acid membrane is fixed between the two fixed frames by crimping; and
the electrolytic diaphragm unit is connected fixedly with the electrolytic tank via the fixed frames.

4. The electrolytic apparatus according to claim 1, wherein the electrolytic apparatus further comprises an electrolyte supplying unit, the electrolyte supplying unit comprises an electrolyte storage unit and an electrolyte supplying pump;
the electrolyte storage unit is communicated with the electrolyte circulating pipeline, and is configured to store the electrolyte; and
the electrolyte supplying pump is configured to transport the electrolyte stored in the electrolyte storage unit into the electrolyte circulating pipeline.

5. The electrolytic apparatus according to claim 1, wherein the electrolytic apparatus further comprises a cooling system configured to lower overall temperature of the electrolyte circulating pipeline.

6. The electrolytic apparatus according to claim 5, wherein the cooling system comprises a cooling water tank, a cooling coil and a cooling water circulating pump;
the cooling water tank is communicated with the cooling coil, and the cooling water tank is configured to accommodate cooling water and supply the cooling water to the cooling coil; and
the cooling water circulating pump is configured to supply power for circulating the cooling water.

7. The electrolytic apparatus according to claim 1, wherein the electrolyte circulating pipeline comprises an electrolyte circulating pump and an electrolyte circulating sensor, the electrolyte circulating pump is configured to supply power for circulating the electrolyte, and the electrolyte circulating sensor is configured to calculate the number of circulations of the electrolyte; and
the generated water circulating pipeline comprises a generated water circulating pump and a generated water circulating sensor, the generated water circulating pump is configured to supply power for circulating the generated water, and the generated water circulating sensor is configured to calculate the number of circulations of the generated water.

8. The electrolytic apparatus according to claim 1, wherein the generated water circulating pipeline comprises a generated water tank, and the generated water tank is provided with an upper limit and a lower limit for liquid level;
if strongly alkaline water, which reaches a standard, is generated, the valve at the water discharge port is opened to enable water discharge; and once a liquid level within the generated water tank reaches the lower limit, the water discharge is stopped; and
once the water discharge is stopped, the valve at the water supply port is opened to enable water supply for the generated water tank; and if the liquid level within the generated water tank reaches the upper limit, the water supply is stopped.

9. The electrolytic apparatus according to claim 1, wherein the electrolytic tank is in number of more than one.

10. The electrolytic apparatus according to claim 1, wherein each of the electrolyte circulating pipeline and the generated water circulating pipeline is provided therein with a full-water detection sensor and a water-shortage detection sensor;
when a liquid level within the electrolyte circulating pipeline or the generated water circulating pipeline reaches a certain value, the respective full-water detection sensor sends an alarm; and
when the liquid level within the electrolyte circulating pipeline or the generated water circulating pipeline is below another certain value, the respective water-shortage detection sensor sends an alarm, and then the electrolytic apparatus stops.
